(19) United States
(12) Patent Application Publication
(10) Pub. No.: US 2007/0219867 A1
(43) Pub. Date: Sep. 20, 2007

(54) SYSTEM AND METHODOLOGY FOR INCENTIVIZING PURCHASERS AND PROVIDING PURCHASE PRICE REWARDS

(76) Inventor: Joseph Mehm, St. Augustine, FL (US)

Correspondence Address: MARK YOUNG, P.A., 12086 FORT CAROLINE ROAD, UNIT 202, JACKSONVILLE, FL, 32225, US

(21) Appl. No.: 11/750,998

(22) Filed: May 18, 2007

(51) Int. Cl. G06Q 30/00

(52) U.S. Cl. 705/14

(57) ABSTRACT

A cost-effective, bounded, scalable method of paying determined portions of a customer's initial purchase price to the customer as rewards for new business that originates from the customer includes rewarding a first purchaser for subsequent purchases originating from such first purchaser, determining an initial purchase amount for an initial purchase by the first purchaser, assigning a first code to the first purchaser for the initial purchase, associating a subsequent purchase with the first code, and providing a reward to the first purchaser for the subsequent purchase associated with the first code. The reward is a determined amount of money paid to the first purchaser, which may equal a determined percentage (e.g., 5% to 30%) of the subsequent purchase. The person making the subsequent purchase may be the same as the first purchaser or another person. Quantitative and temporal bounds may be established. Under the system and method a purchaser may receive cash rewards equal to the purchaser's initial purchase price.

### FIELD OF THE INVENTION

This invention generally relates to purchaser incentive programs, and more particularly, to a cost-effective, bounded, scalable system and method of paying determined portions, up to a cumulative total of 100%, of a customer's initial purchase price to the customer as rewards for new business that originates from the customer.

### BACKGROUND

Merchants face an enduring problem of creating awareness of their products and services with the consumers that desire the products and services. Even the best product or service cannot be sold unless potential consumers are aware of the product's existence and the source of the product. Therefore, many methods have been developed for attracting the attention of potential customers to particular products and services.

Conventional methods of attracting necessary attention include media advertising, direct mail and personal interaction. In recent years, online advertising has grown tremendously in popularity. Today, most businesses promote their products and services on the Internet in one way or another. One of the most popular forms of online advertising is search engine advertising. Typically, the advertiser pays based upon CPM (Cost Per Mille), i.e., exposure of a message to a specific audience priced per thousand (“Mille” in Latin); CPV (Cost Per Visitor) i.e., the delivery of a targeted visitor to the advertisers website; or CPC (Cost Per Click) each selection of a an advertisement. While such advertising has proven to be effective, it can be quite expensive, especially if the advertisement results in considerable traffic but relatively few purchases. For example, marketers may place a banner at the top of another's website that allows users of that website to click on the banner ad to access the marketer's company website. Such a method can be ineffective and inefficient because the company must pay for the banner ads regardless of whether customers actually purchase anything from the advertiser's website.

Another method commonly used to drive business to a website is an affiliate program, which is a program that allows a website owner (i.e., an affiliate) to place a link to, for example, a product and/or a service and receive a commission for purchases made that resulted from a user selecting a link on the affiliate program participant's website. Affiliate programs solve the problem of not paying out advertising dollars until a purchase is actually made. However, affiliate programs are only available to people that have a website, or have the knowledge to set one up. Also, an affiliate program will only be effective if the advertising website can actually drive enough traffic to the advertised website to make the program an effective advertising medium. Additionally, the affiliate is typically a passive participant. Except for posting a link, the affiliate does nothing proactive to encourage a user to visit the linked site and purchase goods or services. Furthermore, an affiliate program can be considerably expensive, providing the affiliate a substantial commission, ad-infinitum.

What is needed is a cost-effective, bounded, scalable, iterative system and methodology for incentivizing purchasers and providing purchase price rewards in online and offline implementations. The invention is directed to overcoming one or more of the problems and solving one or more of the needs as set forth above.

### SUMMARY OF THE INVENTION

To solve one or more of the problems set forth above, in an exemplary implementation of the invention, a cost-effective, bounded, scalable system and method of paying determined portions, up to 100%, of a customer's initial purchase price to the customer as rewards for new business that originates from the customer is provided. In one implementation, a method of rewarding a first purchaser for subsequent purchases originating from such first purchaser includes steps of determining an initial purchase amount for an initial purchase by the first purchaser, assigning a first code to the first purchaser for the initial purchase, associating a subsequent purchase with the first code, and providing a reward to the first purchaser for the subsequent purchase associated with the first code. The reward provided to the first purchaser for the subsequent purchase associated with the first code is a determined amount of money paid to the first purchaser, which may equal a determined percentage (e.g., 5% to 30%) of the subsequent purchase. The step of associating a subsequent purchase with the first code may include receiving the first code from a person making the subsequent purchase. The person making the subsequent purchase may be the same as the first purchaser or not the same as the first purchaser. The code may be an alphanumeric code or a computer software code (e.g., JavaScript code). The step of assigning a first code to the first purchaser for the initial purchase may include providing a card to the first purchaser, wherein the code is displayed on the card.

The system and method may be quantitatively and temporally bounded. A cumulative reward limit may be established. The limit may equal the initial purchase amount. Additionally, an expiration date may be assigned to the first code. After expiration, the use of the code_will no longer result in a reward.

Transaction information for each subsequent purchase originating from the first purchaser may be stored and made accessible online for tracking and review by the rewarded purchaser. The stored information may include a subsequent purchase amount, a subsequent purchase date, an amount of the reward provided to the first purchaser for the subsequent purchase associated with the first code, and a date the reward was provided to the first purchaser for the subsequent purchase associated with the first code. Such information may be made available online to the initial purchaser.

The system and method are scalable in that each subsequent purchaser may be rewarded for further subsequent purchases originating from the subsequent purchaser. This may entail determining an initial subsequent purchase amount for an initial subsequent purchase by the subsequent purchaser, assigning a subsequent code to the subsequent purchaser for the subsequent purchase, associating a further subsequent purchase with the subsequent code, and providing a reward to the subsequent purchaser for the further subsequent purchase associated with the subsequent code. The reward provided to the subsequent purchaser for the further subsequent purchase associated with the subsequent code is a determined amount of money paid to the subsequent purchaser. A cumulative reward limit and an expiration date may be established for the subsequent code. Transaction information for each subsequent purchase originating from such subsequent purchaser may be stored. The transaction information includes a subsequent purchase amount, a subsequent purchase date, an amount of the reward provided to the subsequent purchaser for the subsequent purchase associated with the subsequent code, and a date the reward was provided to the subsequent purchaser for the subsequent purchase associated with the subsequent code.

### BRIEF DESCRIPTION OF THE DRAWINGS

The foregoing and other aspects, objects, features and advantages of the invention will become better understood with reference to the following description, appended claims, and accompanying drawings, where:

FIG. 1 provides a high-level block diagram of an online system for incentivizing purchasers and providing purchase price rewards according to principles of the invention; and

FIG. 2 provides a high-level flowchart of an online method for incentivizing purchasers and providing purchase price rewards according to principles of the invention.

Those skilled in the art will appreciate that the figures are not intended to illustrate every embodiment of the invention. The invention is not limited to the exemplary embodiments depicted in the figures, including the components and steps, and the selection and arrangement thereof.

### DETAILED DESCRIPTION

A cost-effective, bounded, scalable exemplary system and method of paying determined portions of a customer's initial purchase price to the customer as rewards for new business that originates from the customer is provided. The exemplary method includes rewarding a first purchaser for subsequent purchases originating from such first purchaser, determining an initial purchase amount for an initial purchase by the first purchaser, assigning a first code to the first purchaser for the initial purchase, associating a subsequent purchase with the first code, and providing a reward to the first purchaser for the subsequent purchase associated with the first code. The reward is a determined amount of money paid to the first purchaser, which may equal a determined percentage (e.g., 5% to 30%) of the subsequent purchase. The person making the subsequent purchase may be the same as the first purchaser or another person. Quantitative (e.g., maximum cumulative reward limits) and temporal (e.g., code expiration dates) bounds may be established. An exemplary system according to principles of the invention comprises computer components and software modules adapted to perform steps according to methods of the invention.

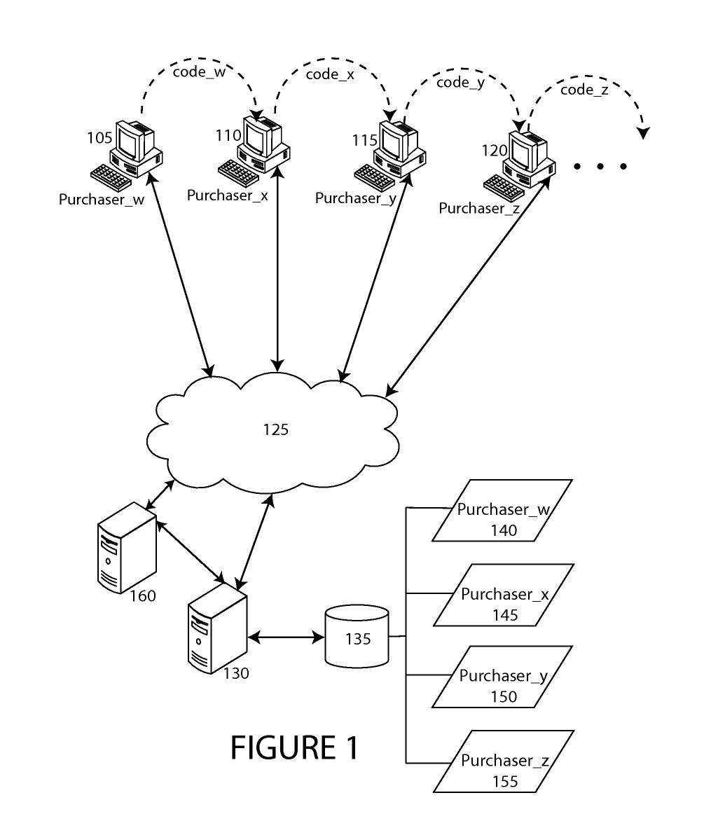

Referring to FIG. 1, a high-level block diagram of an online system in accordance with an exemplary implementation of the invention is shown. A server 130 hosts software for storing data and performing functions according to a methodology of the invention. Purchasers (e.g., Purchaser_w, Purchaser_x, Purchaser_y, Purchaser_z) using client computing devices 105-120 access the server 130 to perform various functions, such as registering, managing their accounts, updating information pertaining to them, and performing transactions. Access to the server 130 (i.e., the “reward program server”) by the plurality of client computing devices 105-120 is preferably via one or more data communications networks, which may include the Internet 125. Merchants offer their goods and/or services to purchasers online through one or more servers such as the merchant server 160, as conceptually illustrated in FIG. 1. Merchant websites may link to the reward program server to facilitate access by participating purchasers. Once a purchaser accesses the server 130, the purchaser may purchase goods or services from participating merchants, or may participate in other available on-line activities. A purchaser may receive credit for participation by others originating from the purchaser. Purchaser and transaction data, such as data sets 140-155, may be stored in one or more local and/or remote data stores, such as database 135, shown in FIG. 1. The database 135 may reside on the server 130 and/or one or more remote computers.

The aforementioned client computing devices 105-120 and servers 130, 160 are intended to represent a broad category of computer systems capable of functioning as computing platforms and hosting operating system and application software for e-commerce in accordance with principles of the invention. Each client computing device 105-120 is configured for communicating requests (e.g., HTTP requests) and responses (e.g., HTTP responses) as well as other data, which may include HTML and XML documents and multimedia objects (images, etc.).

Each server 130, 160 is configured for accepting requests (e.g., HTTP requests) from other computers such as client computing devices 105-120, and serving responses (e.g., HTTP responses) along with optional data contents, which may include Web pages such as HTML and XML documents and multimedia objects (images, etc.). The responses may consist of an HTML document, but can also be a raw text file, an image, or some other type of script, document, applet, file, message, data or information. Each server 130, 160 may have the capability of logging detailed information, about client requests and server responses, to log files, allowing a webmaster to collect statistics by running log analyzers on log files. Such statistics may be used for security monitoring and to optimize performance.

As mentioned above, purchaser and transaction data, such as data sets 140-155, may be stored in one or more local and/or remote data stores, such as database 135, shown in FIG. 1. The database 130 is a structured collection of records or data stored in a computer so that a compatible database management system (DBMS) can manage it. A DBMS controls the organization, storage and retrieval of data in the database 130. The data preferably includes transaction data 140-155 for each purchaser (e.g., Purchaser_w, Purchaser_x, Purchaser_y, Purchaser_z), which may include initial purchase data (e.g., a description of goods/services initially purchased, purchase price, purchase date, and purchaser information) for the purchaser, a purchase code (e.g., code_w, code_x, code_y, code_z) assigned to the purchaser, purchase data (e.g., a description of goods/services purchased, purchase price, purchase date, and purchaser information) for all subsequent purchases made using the code, and reward data (e.g., amounts paid to the purchaser for subsequent purchases under the code, dates of payment, and balance of initial purchase not rewarded to purchaser).

A system and method according to principles of the invention is preferably implemented online, i.e., via computers communicatively coupled to a communications network. However, those skilled in the art will appreciate that offline implementation, i.e., without a computers and/or a communications network, is also feasible and comes within the spirit and scope of the invention. While online implementation is preferred, all modes of implementation of a system and method according to the invention, whether online, offline or otherwise, are intended to come within the scope of the invention.

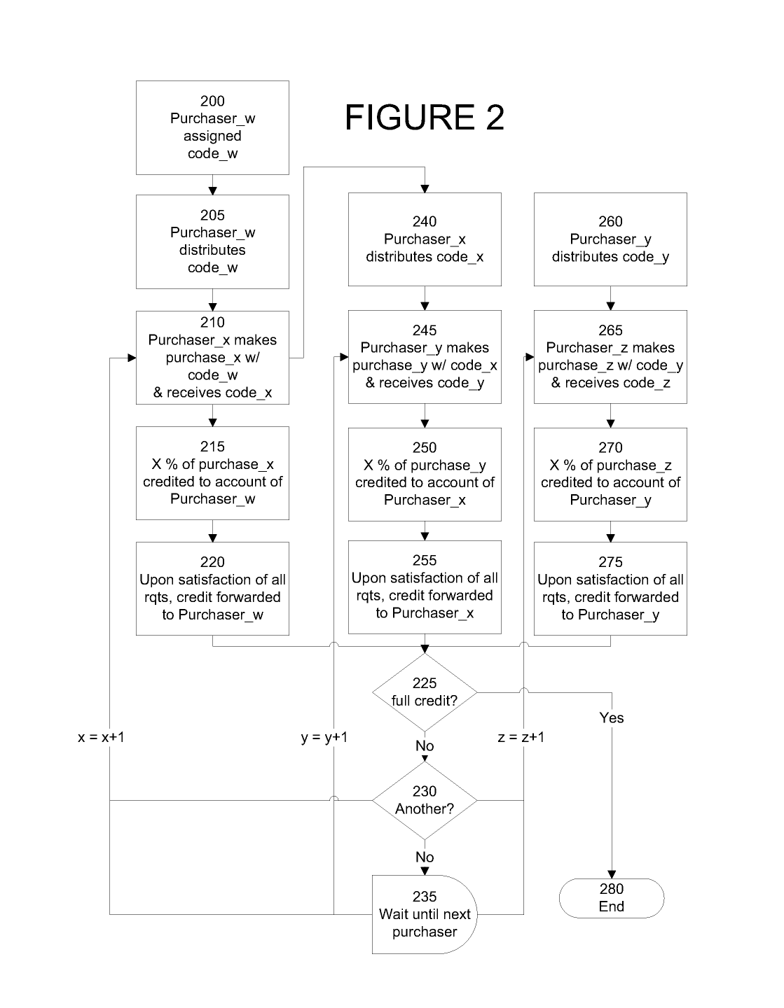

Referring now to FIG. 2, a high-level flowchart of a method for incentivizing purchasers and providing purchase price rewards according to principles of the invention is conceptually illustrated. The method is administered by a service provider, which may be a merchant or a person or entity independent from the merchant, using a server (e.g., server 130). A first purchaser (e.g., Purchaser_w), who has purchased goods and/or services from a merchant, is assigned a purchase code (e.g., code_w) in step 200. The code is any combination of characters (i.e., any data) useful for identifying the purchase transaction. The code is associated with the purchaser and purchase data (e.g., a description of goods/services purchased, purchase price, purchase date, and purchaser information) which is stored in the database 135.

In step 205, the purchaser (Purchaser_w) then directly or indirectly distributes the code to one or more prospective purchasers (e.g., Purchaser_x), i.e., individuals and/or entities that may be interested in purchasing goods/services from the merchant. Such distribution may be in hardcopy, verbally, electronically or any other means or form suitable for communicating the code to a prospective purchaser. For example, the code may be displayed on a card provided to the first purchaser. In addition to or in lieu of a card, the code may be supplied electronically, e.g., in JavaScript code that can be incorporated by the first purchaser onto one or more websites. Such electronic code may be adapted to track all transactions that originate from the first purchaser. Optionally, the merchant may assign an expiration date to the code. In such case, only subsequent purchases before expiration will be eligible to trigger a reward as discussed below. The first purchaser may distribute the code by posting it on a website; incorporating the code into email, SMS messages or other forms of electronic communication; providing the code in writing or verbally to prospective purchasers; or using any other means suitable for dissemination of the code to prospective purchasers. As one non-limiting example, the first purchaser may send a message to a prospective purchaser, such as “Thought you would enjoy this site. It looks like there are some great bargains. They'll even pay you a percentage for referring your friends. Check it out and please use my purchaser code 123456, so that I may earn a reward.”

Next, the prospective purchaser (e.g., Purchaser_x) who has received the code (e.g., code_w) assigned to Purchaser_w, makes a purchase from the corresponding merchant and receives a new code (e.g., code_x), as in step 210. In making the purchase, the prospective purchaser (Purchaser_x) uses the code (e.g., code_w) assigned to Purchaser_w and provided to the prospective purchaser by Purchaser_w. Thus, the prospective purchaser's purchase may be associated with Purchaser_w.

Next, the first purchaser (Purchaser_w) is rewarded for the purchase by each prospective purchaser (e.g., Purchaser_x) using the code (code_w) assigned to the first purchaser. While the reward may be any subject matter of value, in a preferred implementation, it is an amount of money to be paid. The amount may be a predetermined amount such as a fixed fee, a percentage of the purchase by Purchaser_w, a percentage of the purchase by Purchaser_x, a combination of any of the foregoing, or an amount based upon some other formula, as in step 215. In a preferred implementation, the amount is a percentage (e.g., 20%) of Purchaser_x's purchase. In addition, in a preferred implementation, the amount may be subject to a cap, i.e., a limit to a cumulative maximum amount (e.g., a limit of 100% of Purchaser_w's initial purchase). Optionally, a threshold may be set for the amount of a subsequent purchase sufficient to trigger a reward. Thus, for example, the subsequent purchase may have to be at least a certain determined amount before any reward is provided.

The rewarded amount is provided to the rewarded purchaser after all conditions have been satisfied, as in step 220. One such condition may be receipt of payment in full from the prospective purchaser (e.g., Purchaser_x) using the code (code_w). Another condition may be passage of a warranty and/or return time limit (e.g., 30 or 90 days) without a return from the prospective purchaser (e.g., Purchaser_x). After all conditions are satisfied, the rewarded amount is provided to the first purchaser (Purchaser_w).

If the cumulative total rewarded amounts equal or exceed the cap (e.g., a limit of 100% of Purchaser_w's initial purchase), then the process will not repeat, as in steps 225 and 280. However, if the cumulative total rewarded amounts are less than the cap, then the process may repeat, as in steps 225 and 230, for each subsequent purchase using the code, when such subsequent purchaser and/or purchase becomes available, as in step 235.

Optionally, a reward time limit or deadline may be set. For example, rewards may be provided only for subsequent purchases that occur within a determined period of time after the initial purchase (i.e., prior to a deadline). Illustratively, rewards may be available for subsequent purchases made within a year of the initial purchase. The time limit/deadline may be set by associating an expiration date with the code.

By way of example, the cumulative maximum amount may be a percentage (e.g., 100%) of Purchaser_w's initial purchase. In such a case, the first purchaser (Purchaser_w) is rewarded a percentage (e.g., 20%) of each purchase by each subsequent purchaser (e.g., Purchaser_x) using the code (code_w) assigned to the first purchaser, until the cumulative total of all rewards equals Purchaser_w's initial purchase. Thus, the merchant would reward 20% of each subsequent purchase made using the code (code_w), until the cumulative total reward equals 100% of Purchaser_w's purchase price. When the cap of 100% of the initial purchase is reached, the first purchaser (Purchaser_w) has received a reward equal to 100% of the initial purchase.

Those skilled in the art will appreciate that the cap is optional, and in the case of a cap, the cumulative maximum amount may be a percentage other than 100% of Purchaser_w's initial purchase. Additionally, the reward percentage may be an amount other than 20%. Such other implementations come within the spirit and scope of the invention.

The steps described above for the first purchaser are scalable, meaning they may be repeated for each subsequent purchaser originating directly or indirectly from the first purchaser. Illustratively, the second purchaser (e.g., Purchaser_x), who purchased goods and/or services from the merchant under the first purchaser's code (code_w), is assigned a new purchase code (e.g., code_x) in step 210. Again, the code is any combination of characters (i.e., any data) useful for identifying the purchase transaction. The code is associated with the purchaser and purchase data (e.g., a description of goods/services purchased, purchase price, purchase date, and purchaser information) which is stored in the database 135.

In step 240, the second purchaser (Purchaser_x) then directly or indirectly distributes the code to one or more new prospective purchasers (e.g., Purchaser_y), i.e., individuals and/or entities that may be interested in purchasing goods/services from the merchant. Such distribution may be in hardcopy, verbally, electronically or any other means or form suitable for communicating the code to a prospective purchaser. For example, the code may be displayed on a card provided to the second purchaser. In addition to or in lieu of a card, the code may be supplied electronically, e.g., in JavaScript code that can be incorporated by the first purchaser onto one or more websites. Such electronic code may be adapted to track all transactions that originate from the second purchaser. Optionally, the merchant may assign an expiration date to the code. In such case, only subsequent purchases before expiration will be eligible to trigger a reward as discussed below. As with the first purchaser, the second purchaser may distribute the code by posting it on a website; incorporating the code into email, SMS messages or other forms of electronic communication; providing the code in writing or verbally to prospective purchasers; or using any other means suitable for dissemination of the code to prospective purchasers.

Next, the prospective purchaser (e.g., Purchaser_y) who has received the code (e.g., code_x) assigned to Purchaser_x, makes a purchase from the corresponding merchant and receives a new code (e.g., code_y), as in step 245. In making the purchase, the prospective purchaser (Purchaser_y) uses the code (e.g., code_x) assigned to Purchaser_x and provided to the prospective purchaser, directly or indirectly, by Purchaser_x. Thus, the prospective purchaser's purchase may be associated with Purchaser_x.

Next, the second purchaser (Purchaser_x) is rewarded for the purchase by each subsequent purchaser (e.g., Purchaser_y) using the code (code_x) assigned to the second purchaser. While the reward may be any subject matter of value, in a preferred implementation, it is an amount of money to be paid. The amount may be a predetermined amount such as a fixed fee, a percentage of the initial purchase by Purchaser_x in step 210, a percentage of the purchase by Purchaser_y, a combination of any of the foregoing, or an amount based upon some other formula, as in step 250. In a preferred implementation, the amount is a percentage (e.g., 20%) of Purchaser_y's purchase. In addition, in a preferred implementation, the amount may be subject to a cap, i.e., a limit to a cumulative maximum amount. Optionally, a threshold may be set for the amount of a subsequent purchase sufficient to trigger a reward. Thus, for example, the subsequent purchase may have to be at least a certain determined amount before a reward is provided.

The rewarded amount is provided to the rewarded purchaser after all conditions have been satisfied, as in step 255. One such condition may be receipt of payment in full from the prospective purchaser (e.g., Purchaser_y) using the code (code_x). Another condition may be passage of a warranty and/or return time limit (e.g., 30 or 90 days) without a return from the prospective purchaser (e.g., Purchaser_y). After all conditions are satisfied, the rewarded amount is provided to the second purchaser (Purchaser_x).

If the cumulative total rewarded amounts equal or exceed the cap, then the process will not repeat, as in steps 225 and 280. However, if the cumulative total rewarded amounts are less than the cap, then the process may repeat, as in steps 225 and 230, for each subsequent purchase using the code, when such subsequent purchaser and/or purchase becomes available, as in step 235.

Optionally, a reward time limit or deadline may be set. For example, rewards may be provided only for subsequent purchases that occur within a determined period of time after the initial purchase (i.e., prior to a deadline). Illustratively, rewards may be available for subsequent purchases made within a year of the initial purchase. The time limit/deadline may be set by associating an expiration date with the code.

By way of example, the cumulative maximum amount may be a percentage (e.g., 100%) of Purchaser_x's initial purchase. In such a case, the second purchaser (Purchaser_x) is rewarded a percentage (e.g., 20%) of each subsequent purchase by each subsequent purchaser (e.g., Purchaser_y) using the code (code_x) assigned to the second purchaser, until the cumulative total of all rewards equals Purchaser_x's initial purchase. Thus, the merchant would reward 20% of each subsequent purchase made using the code (code_x), until the cumulative total of all rewards equals Purchaser_x's initial purchase. When the cap of 100% of the initial purchase is reached, the second purchaser (Purchaser_x) has received a reward equal to 100% of the initial purchase.

Those skilled in the art will appreciate that the cap is optional, and in the case of a cap, the cumulative maximum amount may be a percentage other than 100% of Purchaser_x's initial purchase. Additionally, the reward percentage may be an amount other than 20%. Such other implementations come within the spirit and scope of the invention.

To further illustrate scalability, the steps described above for the first and second purchasers are repeated for another subsequent purchaser originating directly or indirectly from the second purchaser, in the flowchart of FIG. 2. Illustratively, the third purchaser (e.g., Purchaser_y), who purchased goods and/or services from the merchant under the second purchaser's code (code_x), is assigned a new purchase code (e.g., code_y) in step 245. Again, the code is any combination of characters (i.e., any data) useful for identifying the purchase transaction. The code is associated with the purchaser and purchase data (e.g., a description of goods/services purchased, purchase price, purchase date, and purchaser information) which is stored in the database 135.

In step 260, the third purchaser (Purchaser_y) then directly or indirectly distributes the code to one or more new prospective purchasers (e.g., Purchaser_z), i.e., individuals and/or entities that may be interested in purchasing goods/services from the merchant. Such distribution may be in hardcopy, verbally, electronically or any other means or form suitable for communicating the code to a prospective purchaser. For example, the code may be displayed on a card provided to the third purchaser. In addition to or in lieu of a card, the code may be supplied electronically, e.g., in JavaScript code that can be incorporated by the second purchaser onto one or more websites. Such electronic code may be adapted to track all transactions that originate from the third purchaser. Optionally, the merchant may assign an expiration date to the code. In such case, only subsequent purchases before expiration will be eligible to trigger a reward as discussed below. As with the second purchaser, the third purchaser may distribute the code by posting it on a website; incorporating the code into email, SMS messages or other forms of electronic communication; providing the code in writing or verbally to prospective purchasers; or using any other means suitable for dissemination of the code to prospective purchasers.

Next, the prospective purchaser (e.g., Purchaser_z) who has received the code (e.g., code_y) assigned to Purchaser_y, makes a purchase from the corresponding merchant and receives a new code (e.g., code_z), as in step 265. In making the purchase, the prospective purchaser (Purchaser_z) uses the code (e.g., code_y) assigned to Purchaser_y and provided to the prospective purchaser, directly or indirectly, by Purchaser_y. Thus, the prospective purchaser's purchase may be associated with Purchaser_y.

Next, the third purchaser (Purchaser_y) is rewarded for the purchase by each prospective purchaser (e.g., Purchaser_z) using the code (code_y) assigned to the third purchaser. While the reward may be any subject matter of value, in a preferred implementation, it is an amount of money to be paid. The amount may be a predetermined amount such as a fixed fee, a percentage of the initial purchase by Purchaser_y in step 245, a percentage of the purchase by Purchaser_z, a combination of any of the foregoing, or an amount based upon some other formula, as in step 270. In a preferred implementation, the amount is a percentage (e.g., 20%) of each subsequent purchase under the code (code_y), subject to any applicable limit. In a preferred implementation, the amount may be subject to a cap, i.e., a limit to a cumulative maximum amount. Optionally, a threshold may be set for the amount of a subsequent purchase sufficient to trigger a reward. Thus, for example, the subsequent purchase may have to be at least a certain determined amount before a reward is provided.

The rewarded amount is provided to the rewarded purchaser after all conditions have been satisfied, as in step 275. One such condition may be receipt of payment in full from the prospective purchaser (e.g., Purchaser_z) using the code (code_y). Another condition may be passage of a warranty and/or return time limit (e.g., 30 or 90 days) without a return from the prospective purchaser (e.g., Purchaser_z). After all conditions are satisfied, the rewarded amount is provided to the third purchaser (Purchaser_y).

If the cumulative total rewarded amounts equal or exceed the cap, then the process will not repeat, as in steps 225 and 280. However, if the cumulative total rewarded amounts are less than the cap, then the process may repeat, as in steps 225 and 230, for each subsequent purchase using the code, when such subsequent purchaser and/or purchase becomes available, as in step 235.

Optionally, a reward time limit or deadline may be set. For example, rewards may be provided only for subsequent purchases that occur within a determined period of time after the initial purchase (i.e., prior to a deadline). Illustratively, rewards may be available for subsequent purchases made within a year of the initial purchase. The time limit/deadline may be set by associating an expiration date with the code.

By way of example, the cumulative maximum amount may be a percentage (e.g., 100%) of Purchaser_y's initial purchase. In such a case, the third purchaser (Purchaser_y) is rewarded a percentage (e.g., 20%) of each purchase by each subsequent purchaser (e.g., Purchaser_z) using the code (code_y) assigned to the third purchaser, until the cumulative total of all rewards equals Purchaser_y's initial purchase. Thus, the merchant would reward 20% of each subsequent purchase price to Purchaser_y for each subsequent purchase made using the code (code_y). When the cap of 100% of the initial purchase is reached, the third purchaser (Purchaser_y) has received a reward equal to 100% of the initial purchase.

Those skilled in the art will appreciate that the cap is optional, and in the case of a cap, the cumulative maximum amount may be a percentage other than 100% of Purchaser_y's initial purchase. Additionally, the reward percentage may be an amount other than 20%. Such other implementations come within the spirit and scope of the invention.

While the flowchart in FIG. 2 illustrates the process for three initial purchasers (i.e., Purchaser_w, Purchaser_x and Purchaser_y), each of which constitutes a purchasing tier, the invention is not limited to three tiers. Instead, a system and process according to principles of the invention may be applied to any number of purchasing tiers equal to or greater than one.

A purchaser may access an account management page maintained on the server 130. Upon accessing a merchant's website using an Internet connection and a web browser, the purchaser may click on a button or link to access the purchaser's account, which may take the purchaser to a login screen. At the login screen, the purchaser may type a user name and password to access and account page for the purchaser. The account page may enable management and display/reporting of account information, including purchaser and transaction data, for the purchaser. As mentioned above, transaction data 140-155 for a purchaser (e.g., Purchaser_w, Purchaser_x, Purchaser_y, Purchaser_z), may include initial purchase data (e.g., a description of goods/services initially purchased, purchase price, purchase date, and purchaser information) for the purchaser, a purchase code (e.g., code_w, code_x, code_y, code_z) assigned to the purchaser, purchase data (e.g., a description of goods/services purchased, purchase price, purchase date, and purchaser information) for all subsequent purchases made using the code, and reward data (e.g., amounts paid to the purchaser for subsequent purchases under the code, dates of payment, and balance of initial purchase not rewarded to purchaser). Through the account management page, the purchaser may conveniently update contact information and financial account information and determine amounts paid to the purchaser for subsequent purchases under the code, dates of payment, and balance of initial purchase not rewarded to the purchaser.

Advantageously, a system and method according to principles of the invention provides a strong incentive for a purchaser to make an initial purchase. After doing so, the purchaser may earn valuable rewards by directing other purchaser's to the merchant. In a preferred implementation, the reward program is voluntary, not compulsory.

Those of ordinary skill in the art will, of course, appreciate that various changes in the details, arrangement and choice of equipment and software operation which have been herein described and illustrated in order to explain the nature of the invention may be made by the skilled artisan within the principle and scope of the invention as expressed in the appended claims. While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A method of rewarding a first purchaser for subsequent purchases originating from said first purchaser, said method comprising steps of
determining an initial purchase amount for an initial purchase by said first purchaser,
assigning a first code to said first purchaser for said initial purchase,
associating a subsequent purchase with said first code, and
providing a reward to said first purchaser for said subsequent purchase associated with said first code.

2. A method of rewarding a first purchaser for subsequent purchases originating from said first purchaser according to claim 1, wherein
the reward provided to said first purchaser for said subsequent purchase associated with said first code is a determined amount of money paid to said first purchaser.

3. A method of rewarding a first purchaser for subsequent purchases originating from said first purchaser according to claim 1, wherein
the reward provided to said first purchaser for said subsequent purchase associated with said first code is an amount of money equal to a determined percentage of said subsequent purchase.

4. A method of rewarding a first purchaser for subsequent purchases originating from said first purchaser according to claim 1, wherein
the reward provided to said first purchaser for said subsequent purchase associated with said first code is an amount of money equal to five to thirty percent of said subsequent purchase.

5. A method of rewarding a first purchaser for subsequent purchases originating from said first purchaser according to claim 1, wherein the step of associating a subsequent purchase with said first code includes receiving the first code from a person making the subsequent purchase.

6. A method of rewarding a first purchaser for subsequent purchases originating from said first purchaser according to claim 5, wherein the person making the subsequent purchase is the same as the first purchaser.

7. A method of rewarding a first purchaser for subsequent purchases originating from said first purchaser according to claim 5, wherein the person making the subsequent purchase is not the same as the first purchaser.

8. A method of rewarding a first purchaser for subsequent purchases originating from said first purchaser according to claim 1, wherein the step of assigning a first code to said first purchaser for said initial purchase includes providing an alphanumeric code to said first purchaser.

9. A method of rewarding a first purchaser for subsequent purchases originating from said first purchaser according to claim 1, wherein the step of assigning a first code to said first purchaser for said initial purchase includes providing a computer software code to said first purchaser.

10. A method of rewarding a first purchaser for subsequent purchases originating from said first purchaser according to claim 1, wherein the step of assigning a first code to said first purchaser for said initial purchase includes providing a card to said first purchaser, wherein the code is displayed on the card.

11. A method of rewarding a first purchaser for subsequent purchases originating from said first purchaser according to claim 1, further comprising a step of establishing a cumulative reward limit.

12. A method of rewarding a first purchaser for subsequent purchases originating from said first purchaser according to claim 1, further comprising a step of establishing a cumulative reward limit equal to the initial purchase amount.

13. A method of rewarding a first purchaser for subsequent purchases originating from said first purchaser according to claim 1, wherein the step of assigning a first code to said first purchaser for said initial purchase includes assigning an expiration date to said first code.

14. A method of rewarding a first purchaser for subsequent purchases originating from said first purchaser according to claim 1, further comprising a step of storing transaction information for each subsequent purchase originating from said first purchaser.

15. A method of rewarding a first purchaser for subsequent purchases originating from said first purchaser according to claim 1, further comprising a step of storing transaction information for each subsequent purchase originating from said first purchaser, wherein said transaction information includes a subsequent purchase amount, a subsequent purchase date, an amount of the reward provide to said first purchaser for said subsequent purchase associated with said first code, and a date the reward was provided to said first purchaser for said subsequent purchase associated with said first code.

16. A method of rewarding a first purchaser for subsequent purchases originating from said first purchaser according to claim 1, further comprising a step of
rewarding a subsequent purchaser for further subsequent purchases originating from the subsequent purchaser, said step of rewarding the subsequent purchaser for further subsequent purchases originating from the subsequent purchaser comprising steps of
determining an initial subsequent purchase amount for an initial subsequent purchase by the subsequent purchaser,
assigning a subsequent code to the subsequent purchaser for said subsequent purchase,
associating a further subsequent purchase with said subsequent code, and
providing a reward to the subsequent purchaser for said further subsequent purchase associated with said subsequent code.

17. A method of rewarding a first purchaser for subsequent purchases originating from said first purchaser according to claim 16, wherein
the reward provided to said subsequent purchaser for said further subsequent purchase associated with said subsequent code is a determined amount of money paid to said subsequent purchaser

18. A method of rewarding a subsequent purchaser for subsequent purchases originating from said subsequent purchaser according to claim 17, further comprising a step of establishing a cumulative reward limit.

19. A method of rewarding a subsequent purchaser for subsequent purchases originating from said subsequent purchaser according to claim 18, wherein the step of assigning a subsequent code to said subsequent purchaser for said initial purchase includes assigning an expiration date to said subsequent code.

20. A method of rewarding a subsequent purchaser for subsequent purchases originating from said subsequent purchaser according to claim 19, further comprising a step of storing transaction information for each subsequent purchase originating from said subsequent purchaser, wherein said transaction information includes a subsequent purchase amount, a subsequent purchase date, an amount of the reward provide to said subsequent purchaser for said subsequent purchase associated with said subsequent code, and a date the reward was provided to said subsequent purchaser for said subsequent purchase associated with said subsequent code.
